(19) United States
(12) Patent Application Publication
(10) Pub. No.: US 2023/0288018 A1
(43) Pub. Date: Sep. 14, 2023

(54) MULTIFUNCTIONAL BRACKET

(71) Applicant: YU LOU, Ningbo (CN)

(72) Inventor: YU LOU, Ningbo (CN)

(21) Appl. No.: 17/690,017

(22) Filed: Mar. 9, 2022

(51) Int. Cl. F16M 13/02

(52) U.S. Cl. CPC F16M 13/02; F16M 2200/024

(57) ABSTRACT

A multifunctional bracket, including a base and a sleeve. A connecting portion is disposed on the base, and the connecting portion is configured to realize detachable connection with a logistics carrying equipment. A lower end of the sleeve is rotatably connected with the base, a safety limiting mechanism is further disposed between the lower end of the sleeve and the base, and the safety limiting mechanism is configured to limit a range of a connection angle of the sleeve and the base. The multifunctional bracket disclosed by the present disclosure has advantages of low cost, convenient operation, wide application range and high safety.

### TECHNICAL FIELD

The present disclosure relates to a technical field of logistics equipment, and in particular to a multifunctional bracket.

### BACKGROUND

At present, there is a risk that paper packaging boxes may be damp from rain in transit. Therefore, the packaging boxes are usually wrapped by a plurality of plastic films before shipping to increase waterproof performance.

Nowadays, there are a plurality of goods in a workshop, the goods are messy so that daily supplies such as wrapping films and adhesive taps are not easily to store, which may cause loss of the daily supplies, and the daily supplies cannot be found at a first place when the daily supplies need to be used. Thus, the wrapping films, the adhesive tapes, etc. are usually stored in a special warehouse. When packaging is required, a worker goes to the warehouse to pick up the winding films, and then wraps a product, which causes physical consumption to a certain extent.

Thus, the present disclosure makes full use of an existing logistics carrying equipment in the workshop to develop a bracket specially configured to place the daily supplies such as the wrapping films, the adhesive tapes, etc., the bracket may be directly connected to a variety of the logistics carrying equipment according to actual needs. In this way, when the goods need to be packed with the wrapping films or the adhesive tapes after being carried through the logistics carrying equipment, the goods may be directly removed from the bracket for packing processing, which effectively improves work efficiency.

### SUMMARY

The technical problems to be solved by the present disclosure are as follows. In order to overcome defects in prior art, the present disclosure provides a multifunctional bracket which cost is low, operation is convenient, application range is wide, and has high safety.

Technical scheme adopted by the present disclosure is as follows.

The present disclosure provides a multifunctional bracket including a base and a sleeve. A connecting portion is disposed on the base, and the connecting portion is configured to realize detachable connection with a logistics carrying equipment. A lower end of the sleeve is rotatably connected with the base, a safety limiting mechanism is further disposed between the lower end of the sleeve and the base, and the safety limiting mechanism is configured to limit a range of a connection angle of the sleeve and the base.

Compared with the prior art, the present disclosure has following advantages.

In a bracket structure of the present disclosure, the base is provided, and the base may be applied to a variety of different types of logistics carrying equipment. Besides, the sleeve is rotatably disposed on the base, and the sleeve is configured to store and package daily supplies such as wrapping films, adhesive tapes, etc., which is convenient for a workshop operation worker to obtain the winding films or the adhesive tapes for packaging at any time, and a working efficiency is improved. In addition, due to a fact that the sleeve and the base are rotatably connected, and the respective safety limiting mechanism is disposed at a joint of the sleeve and the base, there are more installation angles for the multifunctional bracket to be selected on the logistics carrying equipment, which achieves higher safety performance. After the selected angle is connected, a problem of loosening of the multifunctional bracket may not occur due to use of the safety limiting mechanism, which is much safer in using.

Furthermore, the safety limiting mechanism includes a safety limiting block, a connecting plate is disposed at the lower end of the sleeve, and the safety limiting block is disposed on the connecting plate through at least one bolt. At least one limiting channel is defined on the base, the at least one limiting channel is configured to accommodate the safety limiting block, and a lower end of the connecting plate is hinged to the base through a rotating shaft.

Optionally, the safety limiting block is of a sector-shaped structure, and the at least one limiting channel is an annular channel matching the limiting block. In the sector-shaped structure, when the connecting plate is rotatably adjusted with the base, the limiting block slides in the annular channel synchronously, which achieves a certain guiding effect\.

Furthermore, a first tooth-shaped protrusion or a first tooth-shaped groove is defined on an inner arc-shaped surface and/or an outer arc-shaped surface of the safety limiting block, and a second tooth-shaped groove or a second tooth-shaped protrusion is respectively defined on an inner arc surface and/or an outer arc surface of the annular channel. A tooth-shaped matching structure is disposed in the structure, so that position limiting stability is further improved, namely that, after a required mounting angle of the multifunctional bracket is achieved, loosening and deflection of the multifunctional bracket may not easily occur.

Furthermore, the base includes a mounting bottom plate. Two positioning plates are disposed on the mounting bottom plate, and a lower end of the connecting plate rotates between the two positioning plates. The annular channels are respectively defined on the two positioning plates. The tooth-shaped protrusion or the tooth-shaped groove is disposed in any one of the annular channels, an end of the at least one bolt penetrates through the connecting plate till penetrating through another one of the annular channels, and an outer end of the at least one bolt is connected with a fastening nut.

Furthermore, a baffle is detachably disposed at an upper end of the sleeve. A structure of the baffle is configured to block the wrapping films or the adhesive tapes or other objects put on the sleeve, so as to prevent the objects from falling out of the sleeve.

Furthermore, a connecting rod is disposed at the upper end of the sleeve, a lower end of the connecting rod is in threaded connection with the sleeve, the baffle is spirally connected to an upper end of the connecting rod, and a distance is reserved between the baffle and a top surface of the sleeve.

Furthermore, a storage plate having holes is disposed on an inner cavity at the upper end of the sleeve, so that a storage cavity is formed at the upper end of the sleeve. The lower end of the connecting rod is screwed in a middle of the storage plate, and a storage space is reserved between the connecting rod and a side wall of the inner cavity of the sleeve.

### BRIEF DESCRIPTION OF DRAWINGS

FIG. 1 is a structural schematic diagram of a multifunctional bracket of the present disclosure.

FIG. 2 is another angle structural schematic diagram of a multifunctional bracket of the present disclosure where the multifunctional is shown in another angle.

FIG. 3 is an exploded schematic diagram of a safety limiting mechanism of the present disclosure.

FIG. 4 is another angle exploded schematic diagram of a safety limiting mechanism of the present disclosure.

FIG. 5 is a connection structural schematic diagram of a baffle, a connecting rod, and a sleeve of the present disclosure.

FIG. 6 is a structural schematic diagram of the multifunctional bracket carrier of the present disclosure where the multifunctional bracket is applied to a carrier.

FIG. 7 is a structural schematic diagram of the multifunctional bracket carrier of the present disclosure where the multifunctional bracket is mounted on another position of the carrier.

Reference number in the figures: carrier main body 100; handle 101; shell 102; safety limiting mechanism 1; sleeve 2; limiting plate 2.1; base 3; mounting bottom plate 3.1; positioning plate 3.2; limiting block 4; connecting plate 5; bolt 6; annular channel 7; rotating shaft 8; baffle 9; connecting rod 10; fastening nut 11; and storage plate 12.

### DETAILED DESCRIPTION

The present disclosure is further described below with reference to accompanying drawings and specific embodiments.

In description of the present disclosure, it should be noted that an orientation or positional relationship indicated by terms “upper end”, “lower end”, “inner arc surface”, “inner arc surface”, “outer arc surface”, “outer end portion”, and the like is based on the orientation or positional relationship shown in the drawings, which is merely for convenience of describing the present disclosure and simplifying the description, rather than indicating or implying that an indicated device or an element must have the specific orientation, be constructed and operated in the specific orientation, and therefore the description should not be construed as a limitation of the present disclosure.

In the description of the present disclosure, it should be noted that, unless expressly specified and defined otherwise, the terms “mounted” and “connected” should be understood broadly, for example, may be fixedly connected or detachably connected or integrally connected, may be mechanically connected or electrically connected, may be directly connected or indirectly connected through an intermediate medium, and may be in communication with an interior of two elements. For a person of ordinary skill in art, specific meanings of the above terms in the present disclosure may be understood according to specific situations.

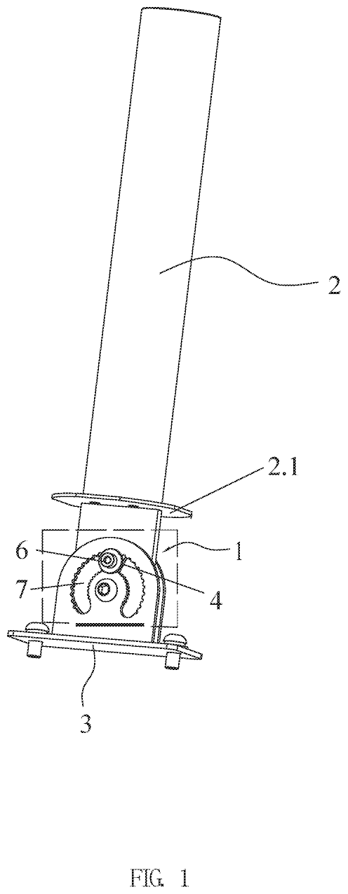

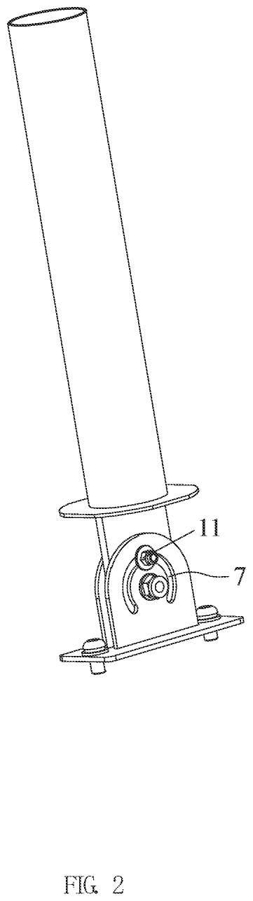

As shown in FIGS. 1-2, the present disclosure provides a multifunctional bracket, including a base 3 and a sleeve 2. A connecting portion is disposed on the base 3, the connecting portion is configured to realize detachable connection with a logistics carrying equipment. Specifically, a respective connecting bolt is disposed on the base 3, the connecting bolt is configured to be connected with the logistics carrying equipment. When using, only respective threaded holes or welding connection nuts are required to be defined on the logistics carrying equipment.

In addition, a lower end of the sleeve 2 is rotatably connected with the base 3, a respective limiting plate 2.1 is further disposed on an outer side wall of the lower end of the sleeve 2, and the limiting plate 2.1 is configured to limit common packaging objects such as winding films, adhesive tapes, etc. sleeving outside the sleeve 2. A safety limiting mechanism 1 is further disposed between the lower end of the sleeve 2 and the base 3, and the safety limiting mechanism 1 is configured to limit a range of a connection angle of the sleeve 2 and the base 3. Specifically, the base 3 is detachably connected to the logistics carrying equipment through a connecting screw, and when the sleeve 2 and the base 3 are rotated to a required connection angle, the sleeve 2 and the base 3 may be fixed and limited through the safety limiting mechanism 1, so that the connection angle is kept unchanged, and when other connection angles of the sleeve 2 and the base 3 are needed for, adjustment of the other connection angles is achieved through the safety limiting mechanism 1.

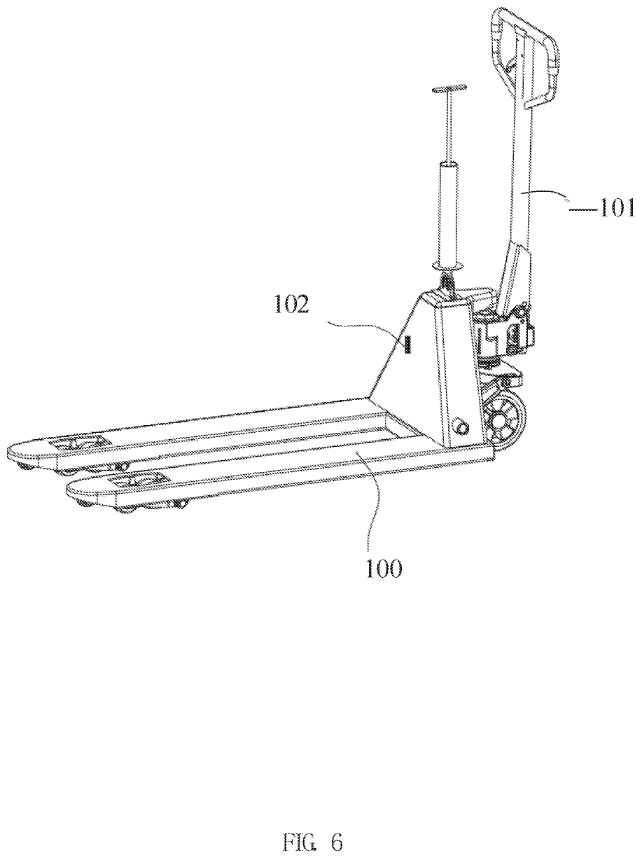

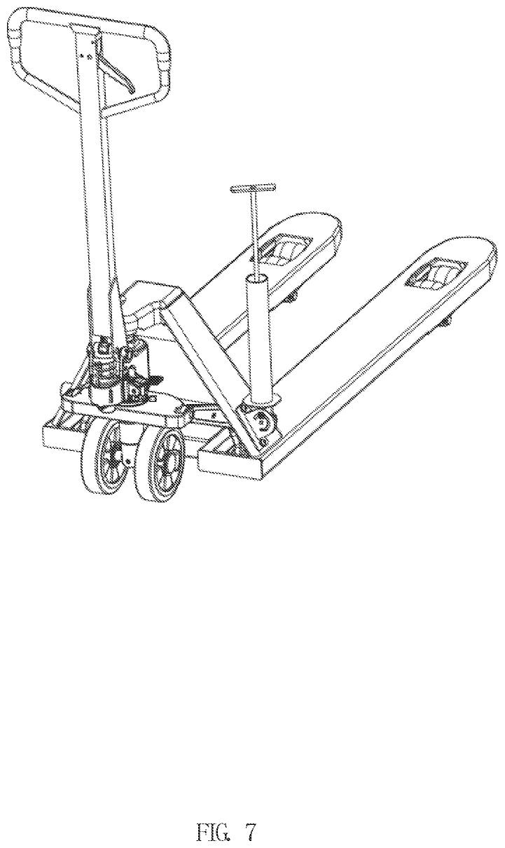

FIGS. 6-7 show an application of the multifunctional bracket and a use of a carrier equipment Specifically, the carrier equipment includes a carrier main body 100, a shell 102 is disposed at one end, close to a handle 101, on the carrier main body 100, and the shell 102 plays a role in protection. In a specific structure of a carrier, a plurality of parts are disposed below the shell 102, the shell 102 may effectively protect the parts from being damaged in a process of carrying goods. In addition, when the multifunctional bracket is installed on the shell 102, normal use of carrying goods may not be affected, and the multifunctional bracket plays a role in temporarily storing common packaging objects such as the winding films, the adhesive tapes, etc. A lower end of the multifunctional bracket is detachably disposed on the shell 102. Specifically, according to work requirements, the lower end of the multifunctional bracket may be installed on a top of the shell 102 (as shown in FIG. 6), or may be installed on a side wall of the shell 102 (as shown in FIG. 7).

In the above structure, when a product needs to be wrapped with the winding films, the winding films may be taken down from the sleeve 2, and the winding films may be artificially circled around the product for packaging. Certainly, the operation worker may further directly push the carrier main body 100 to rotate around the goods that need to be wrapped with the winding films, so that the winding films is wound outside a product packaging box, which is convenient and efficient. On the other hand, in the structure, in order to facilitate a combined use of the winding films and the carrier, a height of the sleeve may further be adjusted, so that winding and packaging of various height products are achieved, and universality is higher.

Certainly, in other embodiments, the multifunctional bracket may be installed on other logistics carrying equipment, such as a stacking high vehicle, etc., and the specific use will not be repeated herewith.

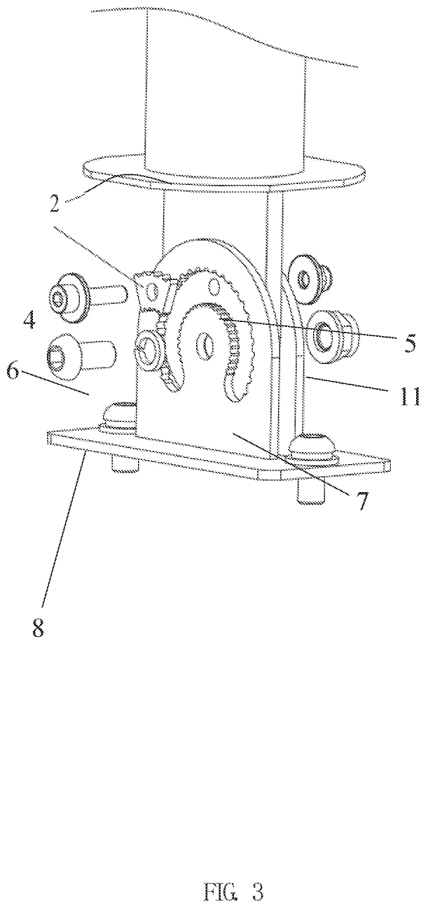

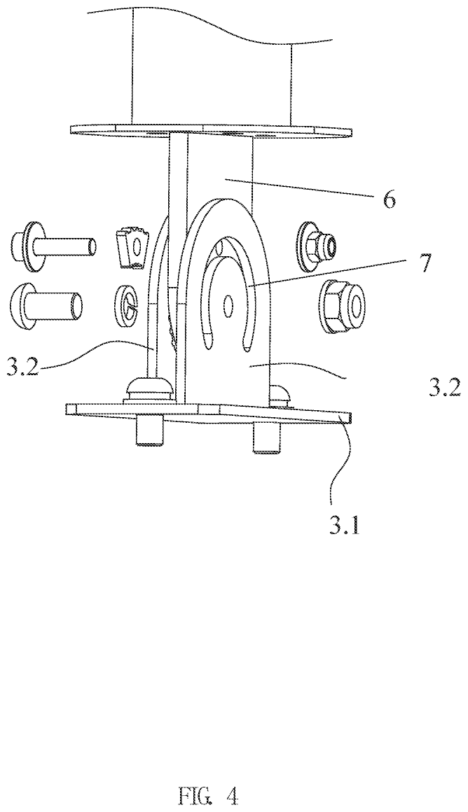

Furthermore, as shown in FIGS. 3-4, the safety limiting mechanism 1 includes a safety limiting block 4, a connecting plate 5 is disposed at the lower end of the sleeve 2, and the safety limiting block 4 is disposed on the connecting plate 5 through at least one bolt 6. At least one limiting channel 7 is defined on the base 3, the at least one limiting channel 7 is configured to accommodate the safety limiting block 4, and a lower end of the connecting plate 5 is hinged to the base 3 through a rotating shaft 8. Specifically, the rotating shaft 8 in the structure is a connecting bolt, and the connecting bolt penetrates out of one end of the base 3 and is fixed through a nut, so that the sleeve 2 and the base 3 may be detachable.

In the structure, the safety limiting block 4 is disposed in the at least one limiting channel 7, and the safety limiting block 4 is fastened and limited through the bolt 6. When it is necessary to adjust an angle, the bolt 6 is loosen, a position of the connecting plate 5 is rotated to adjust. After the connecting plate 5 is adjusted to a required position, the safety limiting block 4 is tighten again, and the safety limiting block 4 is ensured to be disposed in the respective position in the at least one limiting channel 7.

In the embodiment, the safety limiting block 4 is of a sector-shaped structure, and the at least one limiting channel 7 is an annular channel matching the safety limiting block 4. In the structure, in a rotation adjusting process of the connecting plate 5, the safety limiting block 4 further rotates in the at least one limiting channel 7, so that a good guiding effect is achieved. As shown in FIG. 3, in order to further improve stability of limitation of the safety limiting block 4, a first tooth-shaped protrusion or a first tooth-shaped groove is defined on an inner arc-shaped surface and/or an outer arc-shaped surface of the safety limiting block 4, and a second tooth-shaped groove or a second tooth-shaped protrusion is respectively defined on an inner arc surface and/or an outer arc surface of the annular channel. Thus, after the bolt 6 is tightened, a respective tooth-shaped structure enables the safety limiting block 4 to be more stably matched and limited in the annular limiting channel 7, namely that, the lower end of the connecting plate 5 and the base 3 have a more stable anti-rotation effect after the required angle is set, and loosening and rotating may not occur. Specifically, the tooth-shaped protrusions or tooth-shaped grooves in the safety limiting block 4 and the annular limiting channel 7 may be defined only on an inner circular arc surface, or only on an outer circular arc surface, or may be defined simultaneously on both the inner circular arc surface and the outer circular arc surface, so that better anti-rotation limitation is ensured, the sleeve 2 may not be turned over due to loosening of the bolt 6 in a using process, and higher safety performance is achieved.

In addition, as shown in FIG. 4, the base 3 includes a mounting bottom plate 3.1, two positioning plates 3.2 are disposed on the mounting bottom plate 3.1, and a lower end of the connecting plate 5 is rotatably fitted between the two positioning plates 3.2. The annular channels 7 are respectively disposed on the two positioning plates 3.2. The tooth-shaped protrusion or the tooth-shaped groove is disposed in any one of the annular channels 7, an end of the bolt 6 penetrates through the connecting plate 5 till penetrating out of the end of the bolt 6 through another one of the annular channels 7, and an outer end of the bolt 6 is connected with a fastening nut 11. When an angle of the sleeve 2 needs to be adjusted, loosening the fastening nut 11 until the safety limiting block 4 is disengaged from the annular channel 7, and then rotating the sleeve 2. During a rotation adjustment process, the bolt 6 further respectively slides in each of the annular channels 7 of the two positioning plates 6.2. After adjusting to the required angle, re-installing the safety limiting block 4 into a respective position in the annular channels 7, and finally tightening the fastening nut 11.

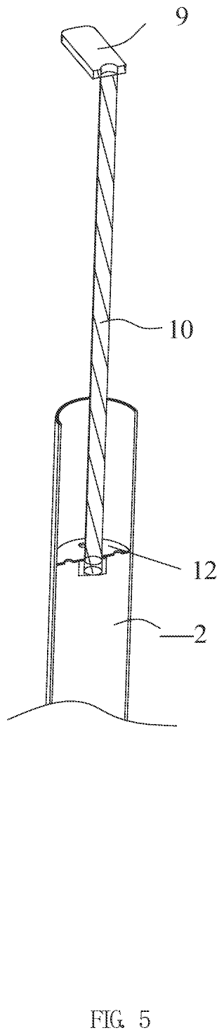

As shown in FIG. 5, a baffle 9 is detachably disposed at an upper end of the sleeve 2. When the winding films or the adhesive tapes are sleeved on the sleeve 2, the baffle 9 is limited and blocked at an outer end of the winding film, so as to prevent the winding films from falling off during a movement process of the logistics carrying equipment or a wrapping process of the winding films by pushing the carrier. Specifically, a connecting rod 10 is disposed at the upper end of the sleeve 2, a lower end of the connecting rod 10 is in threaded connection with the sleeve 2, the baffle 9 is spirally connected to an upper end of the connecting rod 10, and a distance is reserved between the baffle 9 and a top surface of the sleeve 2.

Specifically, a storage plate 12 with a hole is disposed on an inner cavity at the upper end of the sleeve 2, so that a storage cavity is formed at the upper end of the sleeve 2. The lower end of the connecting rod 10 is screwed in a middle of the storage plate 12, a storage space is reserved between the connecting rod 10 and a side wall of the inner cavity of the sleeve 2, and the storage space is configured to store tools such as utility knives, markers, etc. In addition, a plurality of through holes are defined in the storage plate 12 of the structure, which are mainly configured to prevent accumulating water.

The preferred embodiments of the present disclosure are described above, but should not to be construed as limiting claims. The present disclosure is not limited to the above embodiments, and the specific structures thereof allow for variations. Various changes made within a protection scope of the independent claims of the present disclosure are all within the scope of protection of the present disclosure.

What is claimed is:

1. A multifunctional bracket, comprising:
a base (3); and
a sleeve (2);
wherein a connecting portion is disposed on the base (3), the connecting portion is configured to realize detachable connection with a logistics carrying equipment; a lower end of the sleeve (2) is rotatably connected with the base (3), a safety limiting mechanism (1) is further disposed between the lower end of the sleeve (2) and the base (3), and the safety limiting mechanism (1) is configured to limit a range of a connection angle of the sleeve (2) and the base (3).

2. The multifunctional bracket according to claim 1, wherein the safety limiting mechanism (1) comprises a safety limiting block (4), a connecting plate (5) is disposed at the lower end of the sleeve (2), the safety limiting block (4) is disposed on the connecting plate (5) through at least one bolt (6); at least one limiting channel (7) is defined on the base (3), the at least one limiting channel (7) is configured to accommodate the safety limiting block (4); and a lower end of the connecting plate (5) is hinged to the base (3) through a rotating shaft (8).

3. The multifunctional bracket according to claim 2, wherein the safety limiting block (4) is of a sector-shaped structure, and the at least one limiting channel (7) is an annular channel matching the limiting block (4).

4. The multifunctional bracket according to claim 3, wherein a first tooth-shaped protrusion or a first tooth-shaped groove is defined on an inner arc-shaped surface and/or an outer arc-shaped surface of the safety limiting block (4); and a second tooth-shaped groove or a second tooth-shaped protrusion is respectively defined on an inner arc surface and/or an outer arc surface of the annular channel.

5. The multifunctional bracket according to claim 4, wherein the base (3) comprises a mounting bottom plate (3.1); two positioning plates (3.2) are disposed on the mounting bottom plate (3.1), a lower end of the connecting plate (5) rotates between the two positioning plates (3.2); the annular channels are respectively defined on the two positioning plates (3.2); the tooth-shaped protrusion or the tooth-shaped groove is disposed in any one of the annular channels, an end of the at least one bolt (6) penetrates through the connecting plate (5) till penetrating out of another one of the annular channels, and an outer end of the at least one bolt (6) is connected with a fastening nut (11).

6. The multifunctional bracket according to claim 1, wherein a baffle (9) is detachably disposed at an upper end of the sleeve (2).

7. The multifunctional bracket according to claim 6, wherein a connecting rod (10) is disposed at the upper end of the sleeve (2), a lower end of the connecting rod (10) is in threaded connection with the sleeve (2), the baffle (9) is spirally connected to an upper end of the connecting rod (10), and a distance is reserved between the baffle (9) and a top surface of the sleeve (2).

8. The multifunctional bracket according to claim 7, wherein a storage plate (12) having holes is disposed on an inner cavity at the upper end of the sleeve (2), so that a storage cavity is formed at the upper end of the sleeve (2); the lower end of the connecting rod (10) is screwed in a middle of the storage plate (12), and a storage space is reserved between the connecting rod (10) and a side wall of the inner cavity of the sleeve (2).
